(19) United States
(12) Patent Application Publication
(10) Pub. No.: US 2015/0026059 A1
(43) Pub. Date: Jan. 22, 2015

(54) Money Lending Via A Mobile Device

(71) Applicant: Sable and Wolf Limited, London (GB)

(72) Inventors: Sasha Marks, Manchester (GB); Ethan Marks, Manchester (GB)

(21) Appl. No.: 13/946,487

(22) Filed: Jul. 19, 2013

(51) Int. Cl. G06Q 20/32; G06Q 20/40

(52) U.S. Cl. CPC G06Q 20/322; G06Q 20/4037
USPC 705/44; 705/39

(57) ABSTRACT

This disclosure provides a method that allows a person to request money be deposited into his or her account via a request from a mobile device. The method includes receiving a monetary request associated with a person, wherein the monetary request includes a specified amount of money. Additionally, the method includes debiting a first account associated with the customer. Further, the method includes crediting a second account associated with the customer. And in response to the crediting, the method includes transmitting a confirmation. In some embodiments, debiting the first account associated with the customer includes transmitting a premium message to a wireless device associated with the customer. Additional embodiments include debiting the first account associated with the customer by transmitting a debit request to a third-party.

### BACKGROUND

Traditionally, banking and other financial activities needed to be performed locally at a bank. However, mobile devices and computers allow unprecedented ease to manage a person's finances. Without having to go to a physical bank, many routine financial activities can be performed.

### SUMMARY

Many people require money for everyday items, such as milk, cigarettes, bread or a drink whilst out. Mobile devices and other communication devices enable immediate transfer, but delayed payment. If someone is short of money, he or she can use his or her communication device, e.g. a mobile phone, to request a sum of money from a lender to be added on to their monthly bill or to be taken form their current mobile phone balance. Additionally, the amount lent may be debited to other accounts associated with the person.

A first aspect includes a method that allows a person to request money be deposited in his or her account. The method includes receiving a monetary request associated with a person, wherein the monetary request includes a specified amount of money. Additionally, the method includes debiting a first account associated with the customer. Further, the method includes crediting a second account associated with the customer. And in response to the crediting, the method includes transmitting a confirmation.

In some embodiments, debiting the first account associated with the customer includes transmitting a premium message to a wireless device associated with the customer. Additional embodiments include debiting the first account associated with the customer by transmitting a debit request to a third-party. Debiting the first account associated with the customer may also include debiting an amount greater than the specified amount of money. The method may also include verifying the customer has available credit in a first account.

In additional embodiments, crediting the second account associated with the customer includes crediting the second account with an amount equal to the specified amount of money. Receiving a monetary request may incorporate receiving a Short Message Service (SMS) message and transmitting a confirmation may incorporate transmitting an SMS message. In other embodiments receiving a monetary request is performed by receiving data transmitted via a phone call. The data transmitted via a phone call may include one of voice data and touch-tone data. Additionally, receiving a monetary request may include receiving data from a mobile application.

A second aspect includes a system that allows a person to request money be deposited in his or her account. The system includes at least one processor and a memory having stored thereon instructions that, upon execution by the processor, cause the control system to perform functions. The functions include receiving a monetary request associated with a person, wherein the monetary request includes a specified amount of money. Additionally, the functions include debiting a first account associated with the customer. Further, the functions include crediting a second account associated with the customer. And in response to the crediting, the method includes transmitting a confirmation.

In some embodiments, debiting the first account associated with the customer includes transmitting a premium message to a wireless device associated with the customer. Additional embodiments include debiting the first account associated with the customer by transmitting a debit request to a third-party. Debiting the first account associated with the customer may also include debiting an amount greater than the specified amount of money. The functions may also include verifying the customer has available credit in a first account.

In additional embodiments, crediting the second account associated with the customer includes crediting the second account with an amount equal to the specified amount of money. Receiving a monetary request may incorporate receiving a Short Message Service (SMS) message and transmitting a confirmation may incorporate transmitting an SMS message. In other embodiments receiving a monetary request is performed by receiving data transmitted via a phone call. The data transmitted via a phone call may include one of voice data and touch-tone data. Additionally, receiving a monetary request may include receiving data from a mobile application.

A third aspect includes a method that allows a person to request money be deposited in his or her account. The method includes receiving a monetary request associated with a person, wherein the monetary request includes a specified amount of money. Additionally, the method includes verifying the customer has available credit in a first account and debiting a first account associated with the customer. Further, the method includes crediting a second account associated with the customer. And in response to the crediting, the method includes transmitting a confirmation. In some embodiments, the first account is associated with a wireless device of the customer.

### BRIEF DESCRIPTION OF THE FIGURES

FIG. 1 shows an example of a simplified block diagram of a mobile computing device according to some embodiments.

FIG. 2 shows an example method of money lending via a mobile device.

FIG. 3 shows an example method of using a third party as a short term lending provider through premium communication services.

### DETAILED DESCRIPTION

The following detailed description includes references to the accompanying figures. The example embodiments outlined in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

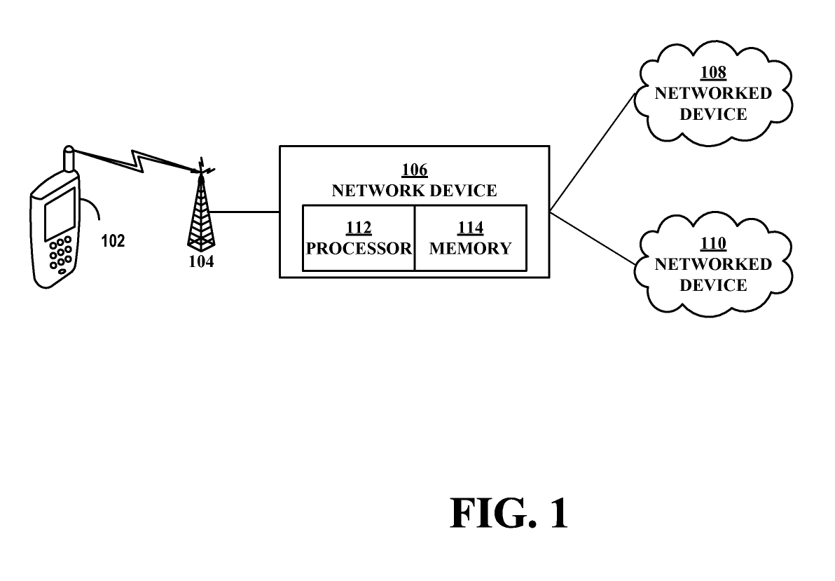

FIG. 1 shows a mobile device 102 communicably coupled to a wireless base station 104. The mobile device 102 may take the form of a cellular phone, smart phone, tablet computer, laptop computer, etc. Additionally, the wireless base station 104 may be a cellular station (such as a GSM, CDMA, LTE, or other cellular-technology station), an IEEE 802.11 base station, or other wireless base station. The mobile device 102 may be able the send messages, such as Short Message Service (SMS) messages, Multimedia Messaging Service (MMS), or other messaging service.

The wireless base station 104 is coupled to a network device 106. Based on various embodiments, as discussed herein, the network device 106 may perform different functionality. In some examples, a wireless service provider may operate the network device 106. In other examples, a bank may operate network device 106. The network device 106 may be a networked computer server.

The networked computer server 106 may contain at least processor 112 and memory 114. The memory 114 may contain both data storage and computer instructions. The data storage may include information related to an account associated with the mobile device 102.

Additionally, the data storage may contain information related to an account (such as a wireless service account or bank account) associated with a customer of the mobile device 102. Further, the computer instructions may include instructions that when executed by the processor 112 cause the performance some or all of the functionality disclosed herein.

The computer server 106 may be coupled to other networked devices 108 and 110. The other networked devices 108 and 110 may take various forms depending on the specific embodiment. In various examples, the other networked devices 108 and 110 may take the form of additional networked servers, addition mobile devices, or any other networked device.

Those skilled in the art will understand that the flow diagrams described herein illustrate functionality and operation of certain implementations of example embodiments. In this regard, each block of each flow diagram may represent a module, a segment, or a portion of program code, which includes one or more instructions executable by a processor (e.g., a processor embedded within mobile device 102) for implementing specific logical functions or steps in the process. The program code may be stored on any type of computer readable medium (e.g., computer readable storage medium or non-transitory media embedded within mobile device 102), for example, such as a storage device including a disk or hard drive. In addition, each block may represent circuitry that is wired to perform the specific logical functions in the process. Alternative implementations are included within the scope of the example embodiments of the present application in which functions may be executed out of order from that shown or discussed, including substantially concurrent or in reverse order, depending on the functionality involved, as would be understood by those reasonably skilled in the art.

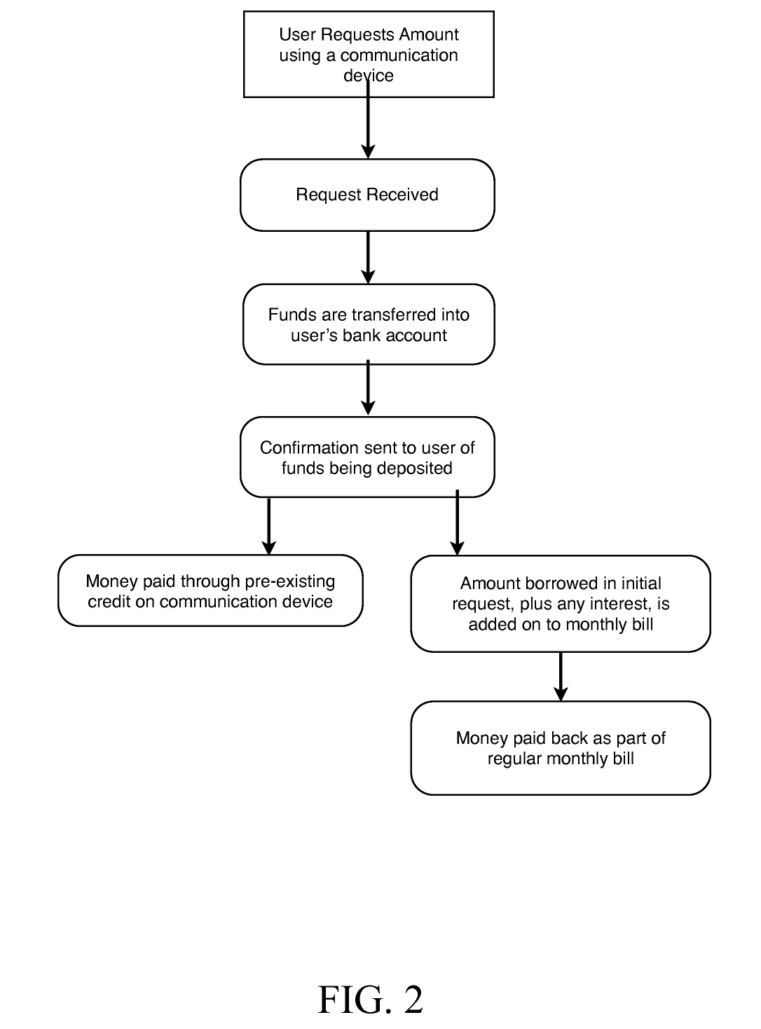

FIG. 2 presents one example method of money lending via a mobile device. As shown in FIG. 2, a customer first requests an amount of money via a communication device (such as the mobile device 102 of FIG. 1). A server (or other computing device, such as network device 106 of FIG. 1) receives the request from the communication device. The amount requested is responsively transferred into a bank account of the customer. A confirmation of the funds-transfer may be communicated back the customer. The customer may then be able to use a debit card (or other means) to withdraw the requested funds.

The server may responsively perform one of two tasks after transferring the funds. First, the server may debit the request against a pre-existing credit associated with a wireless account of the customer of the communication device. Second, the server may add the amount requested to the monthly bill the wireless service provider bills to the customer. There may also be an additional fee, such as interest or a service fee added to the amount transferred. In some embodiments, the monthly bill debited maybe a utility bill (e.g. electricity bill, cable television bill, etc.) associated with the customer.

In another example, an SMS to a specified number may be used to request an amount to be added onto a post-pay mobile phone/broadband/gas/electricity bill in order to receive a cash deposit into a specified bank account. In an additional example, a phone call to a specified number may be used instead of an SMS to request an amount to be added onto a post-pay mobile phone/broadband/gas/electricity bill in order to receive a cash deposit into a specified bank account. In yet another example an ‘app’, i.e. purpose-built computer software such as a mobile application may be used to request an amount to be added onto a post-pay mobile phone/broadband/gas/electricity bill in order to receive a cash deposit into a specified bank account. In a further example, voice authentication, i.e. biometric recognition, may be used to request an amount to be added onto a post-pay mobile phone/broadband/gas/electricity bill in order to receive a cash deposit into a specified bank account.

In one specific example, an AT&T Customer wishes to have $10 deposited into their bank account. Using the method described herein, $10 will be added to his or her bank account, while the $10 and a $3 charge, making the total $13, will be added to his or her bill. This debit can be actioned with a telephone call to a number specified by AT&T for this purpose, after which the desired borrowing amount is input via keypad by the customer. Security and authentication can be done through standard carrier identification methods such as inputting DOB/characters of password, or alternative methods such as biometric voice recognition. The transacted money is recovered by AT&T by adding the amount lent, plus interest, to the customer's monthly telephone bill.

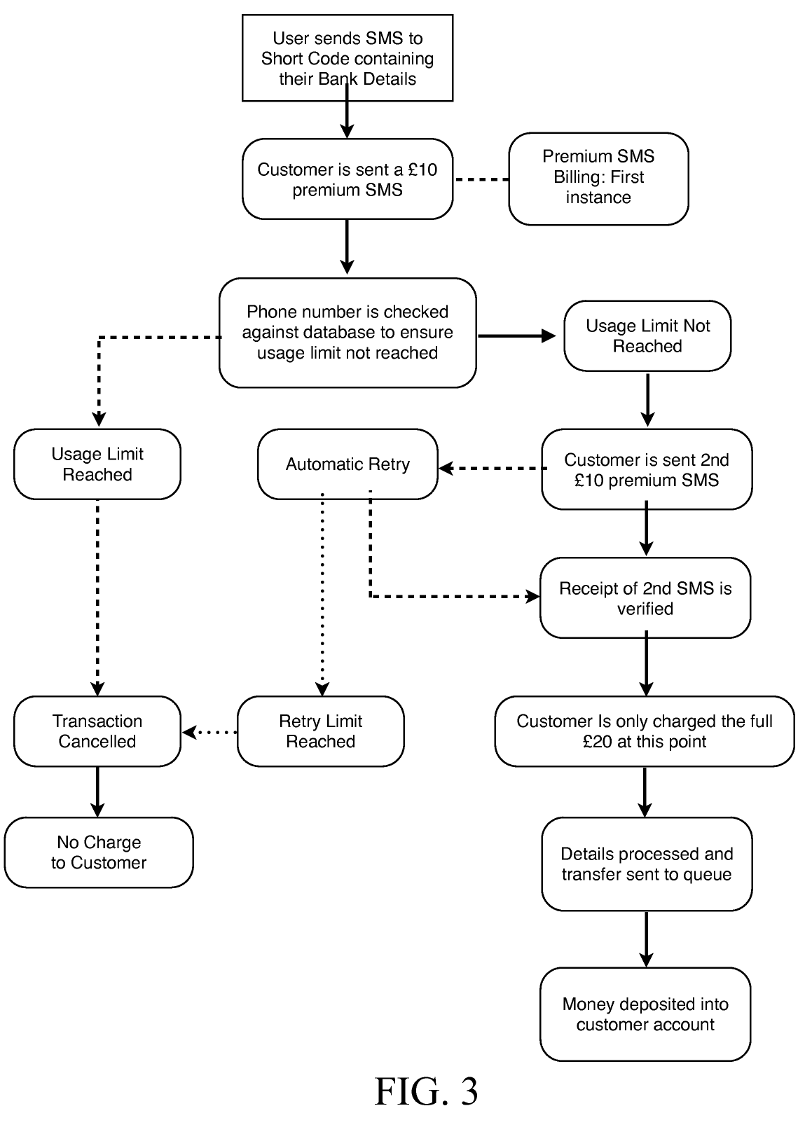

FIG. 3 presents one example method of using a third party as a short term lending provider through premium communication services. This method may enable a customer to action a transfer that is transmitted via premium SMS shortcodes. The customer requests the amount via texting a premium SMS shortcode to the third party. Depending on the amount, the customer may receive one or more premium SMS messages, as some carriers may limit the maximum cost of a premium SMS message.

As further shown in FIG. 3, a customer may send an SMS message to a short code with an amount requested and the customer's bank details. As further shown in FIG. 3, a customer may have requested £20. A server (not shown) associated with the SMS short-code may check the number against a database to make sure the customer has not reached his or her usage limit. If the customer has reached his or her limit, the requested transaction is cancelled. The customer will not be charged the requested amount for a cancelled transaction.

If the customer has not reached his or her limit, the customer will be sent a premium SMS. However, if the amount requested is greater than the maximum amount a premium SMS can charge (£10 is the maximum value for a premium SMS in this example), more than one premium SMS may be sent. In that case, in order for the transaction to be completed, the customer may be sent two £10 messages in return. Until such time as both messages, each valued at £10, have been received the process is not complete. The server may continue to retry sending the premium SMS until the message is successfully sent. However, if a retry limit is reached, the transaction may be cancelled. The loop remains open as if the customer has only received one message; the instruction to deposit money has not yet been received.

The instruction may be completed once the software has received details, which may be sent once both messages have been sent to the customer successfully. The SMS containing the bank details would be received and extracted by the software from a digital format, enabling the server system to communicate directly with a banking terminal in order to queue and transfer deposits into the specified bank account. Once the SMS is verified as delivered, the banking details are placed in a transfer queue and money may be responsively deposited in the customer's account.

In another example, if a customer wishes to borrow £5 (i.e. an amount less than the maximum associated value of a premium SMS), a method similar to that previously discussed may be used. However, only one premium SMS of £10 message may be to be received by the customer. Once the SMS is received, a transfer of a value less than the premium SMS value, such as the requested £5, may be deposited into the customer's account.

In a specific example, a customer wishes to have $10 deposited into their bank account, so they send an SMS to a third party requesting the amount with their bank account details in the message. They will receive two SMS messages confirming the transaction, the first will charge $10 to their bill, which gives the third party $10 less the carrier rebate. The second SMS will provide the third party with $10 minus the carrier rebate, meaning that the third party will have made back the $10 they have lent the customer, plus an additional amount (in immediate interest payment). In this example, if the carrier rebate is $4, then each premium SMS represents $6 to the third party lender, meaning that the $10 lent to the customer, they receive $12 from the premium SMS messages. The customer then pays for the accrued $20 extra in SMS charges through their monthly bill.

In another embodiment, a third party may be used as a short term lending provider. The third party may be made a lender using Premium Phone Call services as the transaction mechanism. In this embodiment, a method enables a customer to action a transfer that is given through automatic recognition of dial tones. The dial tones provide information, such as their bank account identifiers. The customer requests the amount through calling a premium number. He or she may input their details via their communication device keypad, e.g. telephone keypad. The dial tones with corresponding bank details would be received and extracted by the software from a digital format, enabling the software system to communicate directly with a banking terminal in order to queue and transfer deposits into the specified bank account, therefore charging the customer in a way that would equate to the phone call amount totaling the money being lent plus the interest (profit) made on the money being lent to the customer.

Another embodiment includes using a telecoms carrier or other utility provider as a platform for a third party lender to offer short-term loans. Utilities providers may not generally act as direct moneylenders to consumers; however, they may provide an excellent mechanism for an external lender to have access to creditworthiness scores and a channel to deposit money as well as reclaim it.

In one example, a customer sends an SMS to a specified number to request an amount to be added onto a post-pay mobile phone/broadband/gas/electricity bill in order to receive a cash deposit into a specified bank account. This request is automatically vetted by the utility provider, which links, via software, to an external company who provides the funds to be loaned. The loan request is granted and funds are deposited into the customer's account. The way in which the customer repays the loan is through their regular utility bill, where the amount they have borrowed through the SMS Request, plus interest is shown. The utility provider then reimburses the lender the amount loaned and any agreed profit from the interest.

Another example includes using a phone call to a specified number to request an amount to be added onto a post-pay mobile phone/broadband/gas/electricity bill in order to receive a cash deposit into a specified bank account, this request is vetted by the utility provider, which links via software to an external company who provides the funds to be loaned. The loan request is granted and funds are deposited into the customer's account. The customer repays the loan through their regular utility bill, which will have the amount plus interest added. The utility provider then reimburses the lender the amount loaned and any agreed profit from the interest.

A further example includes using an ‘app’, i.e. purpose-built computer software to request an amount to be added onto a post-pay mobile phone/broadband/gas/electricity bill in order to receive a cash deposit into a specified bank account, this request is vetted by the utility provider, which links via software to an external company who provides the funds to be loaned. The loan request is granted and funds are deposited into the customer's account. The customer repays the loan through their regular utility bill, which will have the amount, plus interest, added. The utility provider then reimburses the lender the amount loaned and any agreed profit from the interest.

In yet another example, the method includes using voice authentication, i.e. biometric recognition, to request an amount to be added onto a post-pay mobile phone/broadband/gas/electricity bill in order to receive a cash deposit into a specified bank account, this request is vetted by the utility provider, which links via software to an external company who provides the funds to be loaned. The loan request is granted and funds are deposited into the customer's account. The customer repays the loan through their regular utility bill, which will have the amount, plus interest, added. The utility provider then reimburses the lender the amount loaned and any agreed profit from the interest.

An additional embodiment includes a third party lender using mobile communications to credit check through a telecoms carrier. A customer may use an app or software that requests a money lending facility, which is then sent to the money lending company. The money lending company requests the customer's phone number through the app as a form of credit scoring for the purpose of lending the money. If accepted, the loan is granted to the bank details provided by the customer.

In a different examples, a customer calls a money lending company and uses a dial tone recognition to input their mobile phone number as a way of requesting money. The money lending company uses this phone number for credit scoring for the purpose of lending the money. If accepted, the loan is granted to the bank details provided by the customer.

Additionally, a customer may use an SMS to request money from a moneylender and then is required to input their mobile phone number as a way of validating their creditworthiness. The money lending company uses this phone number for credit scoring for the purpose of lending the money. If accepted, the loan is granted to the bank details provided by the customer.

Additional embodiments include using a mobile app/software to initiate a request for a short-term loan from a mobile carrier. In such embodiments, customers are able to also register their details in the app for quicker future use and can be stored securely in order to expedite any future requests for money.

In one specific example, the customer requests to borrow an amount of money through the use of a mobile app or software. The request is then sent directly to the mobile phone carrier. The app would allow the customer to input specific information in order to receive the money, such as bank account details and also select from within the app the amount they wish to borrow. Once the information has been configured, this request is then submitted. The carrier with which the customer is registered then picks up this request. This information is received, processed, and if the carrier approves the request, the money is then transferred to the specified account. This amount of money, plus any additional charges are then added on to the balance of the customer's monthly bill.

In another example, the customer requests to borrow an amount of money through the use of a mobile app or software, which is then sent directly to the mobile phone carrier. The app for money lending would allow the customer to input specific information in order to receive the money, such as bank account details and also select from within the app the amount they wish to borrow. In order to authenticate this entire process, the customer can use their finger/thumbprint as biometric authentication to ensure the transaction is secure. Once the information has been configured, this request is then submitted. The carrier to which the customer is registered with then picks up this request. This information is received, processed, and if the carrier approves the request, the money is then transferred to the specified account. This amount of money, plus any additional charges, are then added on to the balance of the customer's monthly bill.

In another example, the customer requests to borrow an amount of money through the use of a mobile app or software, which is then sent directly to the mobile phone carrier. The app for money lending would allow the customer to input specific information in order to receive the money, such as bank account details and also select from within the app the amount they wish to borrow. In order to authenticate this entire process, the customer can use their voice as biometric authentication to ensure the transaction is secure. Once the information has been configured, this request is then submitted. The carrier with which the customer is registered then picks up this request. This information is received, processed, and if the carrier approves the request, the money is then transferred to the specified account. This amount of money, plus any additional charges are then added on to the balance of the customer's monthly bill.

An additional example includes the customer requesting to borrow an amount of money through the use of a mobile app or software, which is then sent directly to the mobile phone carrier. The app for money lending would allow the customer to input specific information in order to receive the money, such as bank account details and also select from within the app the amount they wish to borrow. In order to authenticate this entire process, the customer can use carrier-held security information such as date of birth, or a pre-configured password, to ensure the transaction is secure. Once the information has been configured, this request is then submitted. The carrier with which the customer is registered then picks up this request. This information is received, processed and if the carrier approves the request, the money is then transferred to the specified account. This amount of money, plus any additional charges are then added on to the balance of the customer's monthly bill.

Additionally, if the carrier wishes to offer a fixed amount to a pre-registered or already configured bank account via a mobile app, the customer can simply authenticate the request through any number of methods such as voice, thumbprint/fingerprint, password—for instant verification and to immediately execute the transaction.

While various aspects and embodiments have been disclosed herein, other aspects and embodiments will be apparent to those skilled in the art. The various aspects and embodiments disclosed herein are for purposes of illustration only and are not intended to be limiting, with the true scope and spirit being indicated by the following claims.

What is claimed is:

1. A method comprising:
receiving a monetary request associated with a customer, wherein the monetary request includes a specified amount of money;
debiting a first account associated with the customer;
crediting a second account associated with the customer; and
transmitting a confirmation in response to the crediting.

2. The method of claim 1, wherein debiting the first account associated with the customer comprises transmitting a premium message to a wireless device associated with the customer.

3. The method of claim 1, wherein debiting the first account associated with the customer comprises transmitting a debit request to a third-party.

4. The method of claim 1, wherein debiting the first account associated with the customer comprises debiting an amount greater than the specified amount of money.

5. The method of claim 1, wherein crediting the second account associated with the customer comprises crediting the second account with an amount equal to the specified amount of money.

6. The method of claim 1, wherein receiving a monetary request comprises receiving a Short Message Service (SMS) message and wherein transmitting a confirmation comprises transmitting an SMS message.

7. The method of claim 1, wherein receiving a monetary request comprises receiving data transmitted via a phone call.

8. The method of claim 7, wherein the data transmitted via a phone call comprises one of voice data and touch-tone data.

9. The method of claim 1, wherein receiving a monetary request comprises receiving data from a mobile application.

10. A system comprising:
at least one processor; and
a memory having stored thereon instructions that, upon execution by the at least one processor, cause the control system to perform functions comprising:
receiving a monetary request associated with a customer, wherein the monetary request includes a specified amount of money;
debiting a first account associated with the customer;
crediting a second account associated with the customer; and
transmitting a confirmation in response to the crediting.

11. The system of claim 10, wherein debiting the first account associated with the customer comprises transmitting a premium message to a wireless device associated with the customer.

12. The system of claim 10, wherein debiting the first account associated with the customer comprises transmitting a premium message to a wireless device associated with the customer.

13. The system of claim 10, wherein debiting the first account associated with the customer comprises transmitting a debit request to a third-party.

14. The system of claim 10, wherein debiting the first account associated with the customer comprises debiting an amount greater than the specified amount of money.

15. The system of claim 10, wherein crediting the second account associated with the customer comprises crediting the second account with an amount equal to the specified amount of money.

16. The system of claim 10, wherein receiving a monetary request comprises receiving a Short Message Service (SMS) message and wherein transmitting a confirmation comprises transmitting an SMS message.

17. The system of claim 10, wherein receiving a monetary request comprises receiving data transmitted via a phone call.

18. The system of claim 17, wherein the data transmitted via a phone call comprises one of voice data and touch-tone data.

19. A method comprising:
receiving a monetary request associated with a customer, wherein the monetary request includes a specified amount of money;
verifying the customer has available credit in a first account;
debiting a first account associated with the customer;
crediting a second account associated with the customer; and
transmitting a confirmation in response to the crediting.

20. The method of claim 19, wherein the first account is associated with a wireless device of the customer.
